(19) United States
(12) Patent Application Publication
(10) Pub. No.: US 2025/0289484 A1
(43) Pub. Date: Sep. 18, 2025

(54) RAIL SURFACE DEFECT DETECTION FROM ONBOARD VIBRATION SENSORS

(71) Applicant: UNIVERSITY OF SOUTH CAROLINA, COLUMBIA, SC (US)

(72) Inventors: DIMITRIOS C. RIZOS, COLUMBIA, SC (US); REZA NASERI, COLUMBIA, SC (US); BRENNAN L. GEDNEY, COLUMBIA, SC (US)

(21) Appl. No.: 19/070,940

(22) Filed: Mar. 5, 2025

Related U.S. Application Data
(60) Provisional application No. 63/565,581, filed on Mar. 15, 2024.
(60) Provisional application No. 63/704,182, filed on Oct. 7, 2024.

(51) Int. Cl. B61K 9/08; G01P 15/00

(52) U.S. Cl. CPC B61K 9/08; G01P 15/00

(57) ABSTRACT

The disclosure deals with methodology and system subject matter for early detection of Rail Surface Spot Irregularities (RSSI), while damage is still minor in severity. Minor RSSI can be simply resurfaced, and thus far more cost-effective than rail replacement/advanced RSSI. The subject disclosure is a hybrid RSSI detection algorithm that integrates Wavelet Packet Analysis (WPA) and the Hilbert-Huang Transform (HHT), leveraging Axle Box Acceleration (ABA) data obtained from in-service trains. The hybrid approach also addresses challenges posed by non-linear effects and background noise in ABA signal processing. ABA records collected from an instrumented railcar under regular passenger service operations are used per presently disclosed technology to accurately predict both the length and location of RSSI.

### PRIORITY CLAIM

The present application claims the benefit of priority of U.S. Provisional Patent Application No. 63/565,581, filed Mar. 15, 2024, and the benefit of priority of U.S. Provisional Patent Application No. 63/704,182, filed Oct. 7, 2024, both of which are titled Rail Surface Defect Detection From Onboard Vibration Sensors, and both of which are fully incorporated herein by reference for all purposes.

### BACKGROUND OF THE PRESENTLY DISCLOSED SUBJECT MATTER

The disclosure deals with a system and method for early detection of Rail Surface Spot Irregularities (RSSI), while damage is still minor in severity. Stated another way, the present disclosure relates generally to the implementation of a monitoring system for the rapid identification of Rail Surface Spot Irregularities (RSSI).

Maintaining the railroad infrastructure in a state of good repair to prevent failure and service disruptions is a challenge of paramount importance to the safety and economy of operations. Rail Surface Spot Irregularities (RSSI) are among the most common types of damage in railway networks that affect track operating conditions and dramatically increase the risk of rail break, track failure and derailments. Such irregularities are local defects on the rail surface arising from rolling contact fatigue (e.g. squats, spalling, or shelling), joints and welds, among others, and will grow as load accumulates. RSSI sizes (wavelengths) vary from about a few centimeters when they initially form to as much as one meter after load accumulation. Relative to random irregularities, RSSI consists of shorter wavelengths that induce significant dynamic excitation on the track and track structures. RSSI significantly increases the wheel-rail dynamic forces and the wheel unloading rate. Despite the localized nature of RSSI damage, both the track and train responses are impacted. As a result of such high stress fluctuations, components of the rail system deteriorate rapidly leading to worsening of operating conditions and safety. Lack of early detection and mitigation may lead to catastrophic events.

Several existing products, services, and processes endeavor to address the challenge of detecting rail surface irregularities in railway systems.

1. Ultrasonic Inspection Systems: Brands: Sperry Rail Service, NDT Global, Eddyfi Technologies. Companies such as Sperry Rail Service offer ultrasonic inspection services for detecting defects in rails. These systems use ultrasound to identify flaws and irregularities in the rail structure.

2. Eddy Current Inspection Systems: Brands: Zetec, Eddyfi Technologies. Eddy current inspection systems, like those provided by Zetec and Eddyfi Technologies, use electromagnetic induction to identify surface and near-surface defects in rails.

3. Automated Track Inspection Cars: Brands: Geometry Cars by Loram, Track Geometry Measurement System (TGMS) by Harsco Rail. Loram and Harsco Rail provide automated track inspection cars equipped with various sensors to assess track geometry and identify potential issues.

4. Optical Inspection Systems: Brands: OptiTrack by Frauscher Sensor Technology. Optical inspection systems like OptiTrack use cameras and image processing to monitor rail conditions and detect anomalies.

5. Machine Learning-Based Systems: Brands: RailVision by Perpetuum, RailINSIGHT by Balfour Beatty. Some companies, such as Perpetuum and Balfour Beatty, offer machine learning-based systems for railway track monitoring, analyzing data to predict potential issues.

6. Laser-Based Inspection Systems: Brands: RailQ by Nederlandse Spoorwegen (NS), RILA by Speno International. Laser-based inspection systems, such as RailQ and RILA, utilize laser technology to scan and analyze rail surfaces for defects.

7. Magnetic Flux Leakage (MFL) Inspection Systems: Brands: Magneforce by BAE Systems, InspecTrack by BNSF Railway. Magnetic Flux Leakage systems, like Magneforce and InspecTrack, use magnetic fields to detect flaws and irregularities in the rail structure.

8. Acoustic Monitoring Systems: Brands: AcousticRail by Fraunhofer Institute, Acoustic Bearing Monitor by Pandrol. Acoustic monitoring systems, like AcousticRail and Acoustic Bearing Monitor, use sound and vibration analysis to detect anomalies in the rail and bearings.

9. Trackside Vibration Monitoring: Brands: Squeal and Groan Monitor by DeltaRail, Trackside Acoustic Detection System (TADS) by Siemens. Trackside vibration monitoring systems, such as Squeal and Groan Monitor and TADS, analyze vibrations to identify potential issues with the track.

10. Innovative Rail Materials: Brands: CORTEN rail by ArcelorMittal, Heat-Treated Rail by voestalpine. Some companies focus on developing innovative rail materials with enhanced durability and resistance to wear and tear.

With nearly 140,000 miles of track and over 100,000 bridges, railroad roughly covers 42% of all the intercity revenue freight in terms of ton-miles in North America, which is 12% more than highway revenue. Each day, railroad carries approximately one-third of U.S. exports and delivers five million tons of freight and approximately 85,000 passengers (Amtrak only). Maintaining the railroad infrastructure in a state of good repair to prevent failure and service disruptions is a challenge of paramount importance to the safety and economy of operations. The railway network is owned by railroad companies that are the primary customers and potential users of the presently disclosed technology.

### SUMMARY OF THE PRESENTLY DISCLOSED SUBJECT MATTER

Generally, the RSSI effects on the lifecycle of the railway infrastructure and safety of operations are well known. Early detection of Rail Surface Spot Irregularities (RSSI), when damage is minor in severity, holds significant advantages for maintenance operations. Minor RSSI can be simply resurfaced, which is far more cost-effective compared to the rail replacement often necessitated by advanced RSSI. The presently disclosed innovation is a hybrid RSSI detection algorithm that integrates Wavelet Packet Analysis (WPA) and the Hilbert-Huang Transform (HHT). Leveraging Axle Box Acceleration (ABA) data obtained from in-service trains, this algorithm aims to detect minor RSSI early on, enabling cost-effective maintenance operations. The hybrid approach not only enhances RSSI detection efficiency but also addresses challenges posed by non-linear effects and background noise in ABA signal processing. This innovation provides a comprehensive and effective solution for early RSSI detection, enabling proactive maintenance strategies and contributing to improved railway maintenance practices. Furthermore, the presently disclosed method achieves remarkable data compression of the recorded signals, by as much as 95%, all while retaining essential information needed for precise RSSI identification.

The presented algorithm is first implemented in a numerically simulated environment that accounts for various levels of background noise contamination in the measurements. Subsequently, the presently disclosed method is validated through field measurements. To this end, ABA records collected from an instrumented railcar under regular passenger service operations were obtained. The presently disclosed algorithm was implemented and successfully identified the locations and dimensions of multiple RSSIs on each rail of the track. The presently disclosed method accurately predicts both the length and location of RSSI. This dual-validation process proves the algorithm's robustness and applicability in real-world scenarios, emphasizing its potential for transforming railway maintenance practices through early and precise RSSI detection.

The presently disclosed innovation is a new algorithm developed to detect early signs of rail surface defects, known as Rail Surface Spot Irregularities (RSSI), on train tracks. The presently disclosed technology is an automated system for RSSI detection, localization and severity evaluation that combines acceleration sensors, edge computing, and digital communications in one, low-cost, fast, accurate, and integrated system that allows for continuous rail surface health monitoring at train operating speeds. At the core of the presently disclosed system is a novel, and efficient damage identification algorithm presently developed for rapid RSSI detection and characterization. By leveraging real data from in-service trains and employing the presently disclosed novel combination of advanced signal processing techniques, this technology can identify minor, early stage RSSI, enabling prompt and cost-effective maintenance. Additionally, the innovation achieves significant data compression, ensuring crucial information retention without requiring extensive computing and data storage resources. This innovation has the potential to revolutionize online railway maintenance practices by offering a comprehensive solution for proactive RSSI management.

The presently disclosed subject matter relates generally to sensor technology, and in some instances relates further to squat detection, track monitoring, onboard damage detection, wavelet packet analysis, Hilbert-Huang Transform, Axle Box Acceleration (ABA) features or subject matter.

While the immediate impact of RSSI on wheel-rail interaction is evident, existing methods for detecting these defects have limitations. Traditional practices for RSSI detection involve manual inspection by trained personnel, which is labor-intensive, inefficient, and subject to inspector's skill level. Current development efforts focus on automated detection systems, including ultrasonic, eddy current, magnetic flux leakage, laser scanning, and image processing techniques. However, these techniques face practical constraints such as train speed requirements, limited deployment, high equipment costs, and reliability issues. Recent advancements in AI and machine learning-based optical inspection techniques show promise but are sensitive to factors like lighting conditions and vehicle speed, which affect image quality and detection accuracy. Alternatively, vibration-based techniques using measurements from onboard sensors have gained attention, with potential benefits in detecting RSSI and other defects.

Axle Box Acceleration (ABA) data offers several advantages, including its non-disruptive and cost-effective integration into railcars during normal operations and the collection of data from loaded tracks, where dynamic impacts from RSSI are more pronounced. By leveraging ABA data, a proactive warning system can be established to prevent the progression of RSSI and support effective corrective maintenance strategies. This approach not only reduces time and resource expenditures but also enables real-time defect identification, facilitating prompt corrective actions. RSSI detection from ABA records is influenced by non-linear effects and background noise, making it difficult to employ standard signal processing techniques effectively. Classical methods like the Fourier Transform, Hilbert-Huang Transform, and Wavelet Decomposition lack the ability to localize defects in onboard monitoring systems and suffer from low resolution in the time-frequency domain. While the discrete wavelet transform offers better time-frequency resolution, it may not capture high-frequency transient components. In contrast, WPA can address this limitation but may face challenges with train-track frequencies and coupling frequencies. HHT can handle non-stationary and nonlinear data but is sensitive to noise.

To overcome these limitations, the presently disclosed technology integrates both WPA and HHT to create an algorithm that effectively handles stationary and non-stationary data, even in noisy conditions. This integration capitalizes on the strengths of each method, mitigating their individual limitations and resulting in improved overall performance.

The presently disclosed technology uses data that railroads already collect, thus, it: (1) reduces implementation and operation costs, (2) facilitates frequent inspection of the network for rail surface defects since every railcar can potentially be equipped with the presently disclosed system, (3) increases revenue by facilitating targeted maintenance, (4) promotes safety, (5) alleviates disadvantages and limitations of existing methods.

In one exemplary embodiment herewith, presently disclosed methodology relates to a method for the identification of Rail Surface Spot Irregularities (RSSI) of a rail system. Such method preferably comprises collecting field data using at least one accelerometer attached to at least one railcar axle box while synchronously recording associated railcar speed profile and GPS information; processing collected field data using a two stage process of Wavelet Packet Analysis (WPA) and the Hilbert-Huang Transform (HHT) for detecting localized anomalies in the rail system; and identifying and classifying RSSI based on the detected localized anomalies output of the two stage process.

Yet another exemplary method in accordance with presently disclosed subject matter relates to a hybrid methodology for using field data from in-service trains to predict Rail Surface Spot Irregularities (RSSI) of a rail system used by the trains, to provide continuous rail surface health monitoring at train operating speeds, to allow for appropriate corrective action for determined RSSI. Such methodology preferably comprises conducting automated collecting of Axle Box Acceleration (ABA) data obtained from in-service trains having at least one instrumented railcar; synchronously recording associated train speed profile and GPS information with the ABA data; conducting hybrid processing of the recorded field data and associated speed profile and GPS information by first conducting Wavelet Packet Analysis (WPA) processing to partition the recorded field data into distinct frequency bands, for filtering out noise to provide filtered signals, and secondly conducting Hilbert-Huang Transform (HHT) processing on the filtered signals from the WPA processing to extract instantaneous frequency information, to detect changes in amplitude and frequency content over time, for analysis of non-stationary and nonlinear data for detecting localized defects on the rails of the rail systems used by the trains; and identifying and classifying RSSI based on the localized defects detected by the hybrid processing.

It is to be understood that the presently disclosed subject matter equally relates to associated and/or corresponding systems and apparatuses.

Other example aspects of the present disclosure are directed to systems, apparatus, tangible, non-transitory computer-readable media, user interfaces, memory devices, and electronic devices for railway sensor signal processing. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a detection system for the identification of Rail Surface Spot Irregularities (RSSI) of a rail system. Such detection system preferably comprises at least one accelerometer attached to at least one railcar axle box for collecting Axle Box Acceleration (ABA) field data obtained from the at least one railcar axle box; and one or more processors programmed for: (1) synchronously acquiring associated railcar speed profile and GPS information; (2) processing collected data using a two stage process of Wavelet Packet Analysis (WPA) and the Hilbert-Huang Transform (HHT) for detecting localized anomalies in the rail system, and (3) identifying and classifying detected RSSI based on the localized anomalies output of the two stage process.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIGS. 1(a) and 1(b), respectively, are schematic representations of upward and downward Rail Surface Spot Irregularities (RSSIs) for known (Prior Art) wheel-rail interaction force time histories;

FIG. 2 schematically represents an exemplary mounted accelerometer on an exemplary railway axle box and the Axle Box Acceleration (ABA) measurements as the wheel crosses over a representative RSSI;

FIGS. 3(a) through 3(c) respectively represent diagrammatically three successive modules or phases of the presently disclosed RSSI detection methodology;

FIG. 4 schematically represents the interaction of an exemplary single degree-of-freedom oscillator on an irregular surface (such as a railway rail);

FIG. 5(a) graphically illustrates normalized acceleration of an exemplary oscillator (such as represented in present FIG. 4) throughout its motion;

FIG. 5(b) graphically illustrates an enlarged representation of an exemplary oscillator signal in an exemplary defected location in the middle of the path of the exemplary oscillator;

FIG. 6 graphically represents an exemplary output signal of the presently disclosed methodology, as output from the Wavelet Packet Analysis (WPA) portion thereof, for illustrating high-frequency components for SNR=15;

FIG. 7, in accordance with exemplary presently disclosed methodology, graphically represents the frequency details (distribution) of the modified signal of FIG. 6, providing a comprehensive view into the specific frequency components that are of importance in the context of identifying and characterizing localized imperfections, for analysis purposes; and

FIGS. 8(a) and 8(b) graphically represent time-frequency representations of the analytic signals after further refinement through the HHT phase of the presently disclosed process, shown along the entire pathway for both representative noisy environments of introduced Gaussian white noise with SNR values of 15 and 20 dB, respectively.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to methodology and systems for early detection of Rail Surface Spot Irregularities (RSSI), while damage is still relatively minor.

Early detection of Rail Surface Spot Irregularities (RSSI), when damage is minor in severity, holds significant advantages for maintenance operations. Minor RSSI can be simply resurfaced, which is far more cost-effective compared to the rail replacement often necessitated by advanced RSSI. The presently disclosed technology presents a novel RSSI detection method which consists of a hybrid approach combining Wavelet Packet Analysis (WPA) and the Hilbert-Huang Transform (HHT). The presently disclosed technique capitalizes on the strengths of each method, mitigating their individual limitations and resulting in improved overall performance. The method extracts RSSI locations along a track through analysis of Axle Box Acceleration (ABA) data from an in-service train. The presented algorithm is implemented in a numerically simulated environment that accounts for various levels of background noise contamination in the measurements. The hybrid method successfully identified the locations and dimensions of the localized imperfection on each surface.

### 1. INTRODUCTION

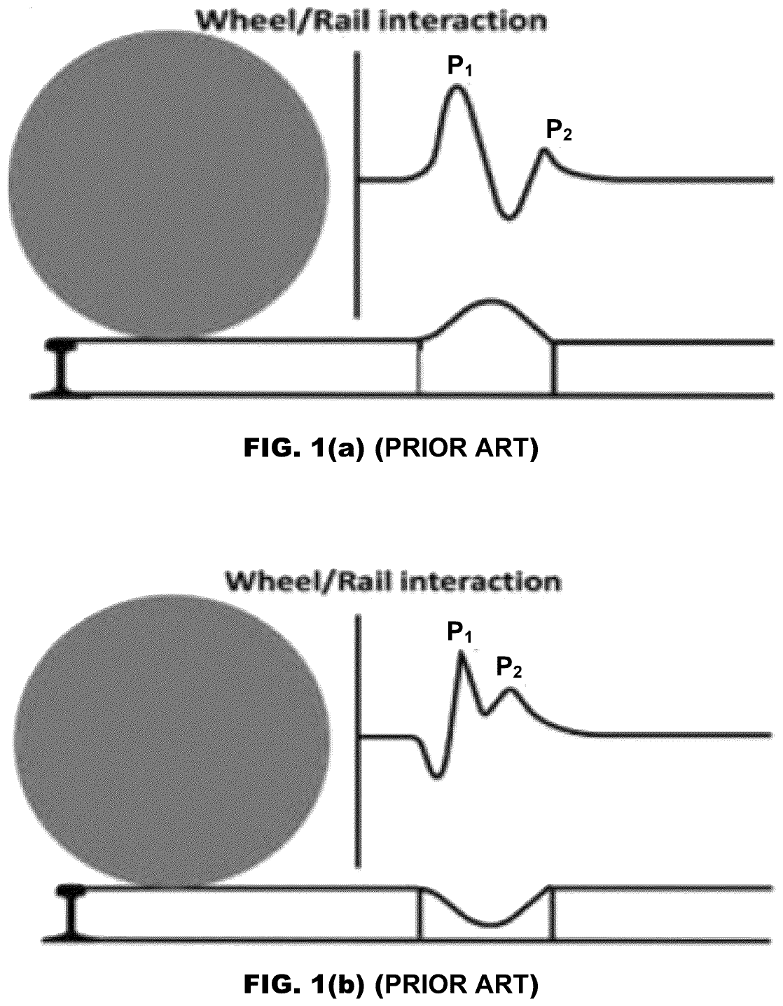

Rail Surface Spot Irregularities (RSSI) represent a common challenge within railway networks, significantly impacting track operating conditions and posing a substantial risk of rail breakage, track failures, and derailments [1-5]. These irregularities result from localized defects on rail surfaces, that initialize primarily due to rolling contact fatigue [6, 7] and issues related to joints and welds [8, 9], and damage accumulates and grows over time as trains pass over [10, 11]. Extensive research has demonstrated that RSSI substantially increase wheel-rail dynamic forces and the wheel unloading rate [12-16], potentially leading to severe consequences, including derailments and substantial financial losses [17, 18]. Schematics for known wheel-rail interaction force time histories for both upward and downward RSSIs, respectively, are represented in FIGS. 1(a) and 1(b). In particular, the stress generated by wheel-rail interaction due to RSSI can exceed 1000 MPa (Megapascal; where one MPa≈145 psi), with shorter wavelength RSSI causing stress concentrations exceeding 4000 MPa [19]. The detrimental effects of such high stress fluctuations on rail system components necessitate early detection and mitigation to prevent catastrophic events [15, 20].

While the immediate impact of RSSI on wheel-rail interaction is evident, existing methods for detecting these defects have limitations. Traditional practices for RSSI detection involve manual inspection by trained personnel, which is labor-intensive, inefficient, and subject to inspector's skill level [21, 22]. Current development efforts focus on automated detection systems, including ultrasonic, eddy current, magnetic flux leakage, laser scanning, and image processing techniques. However, these techniques face practical constraints such as train speed requirements, limited deployment, high equipment costs, and reliability issues [23-27]. Recent advancements in AI and machine learning-based optical inspection techniques show promise but are sensitive to factors like lighting conditions and vehicle speed, which affect image quality and detection accuracy [28-31]. Alternatively, vibration-based techniques using measurements from onboard sensors have gained attention, with potential benefits in detecting RSSI and other defects [21, 32-36].

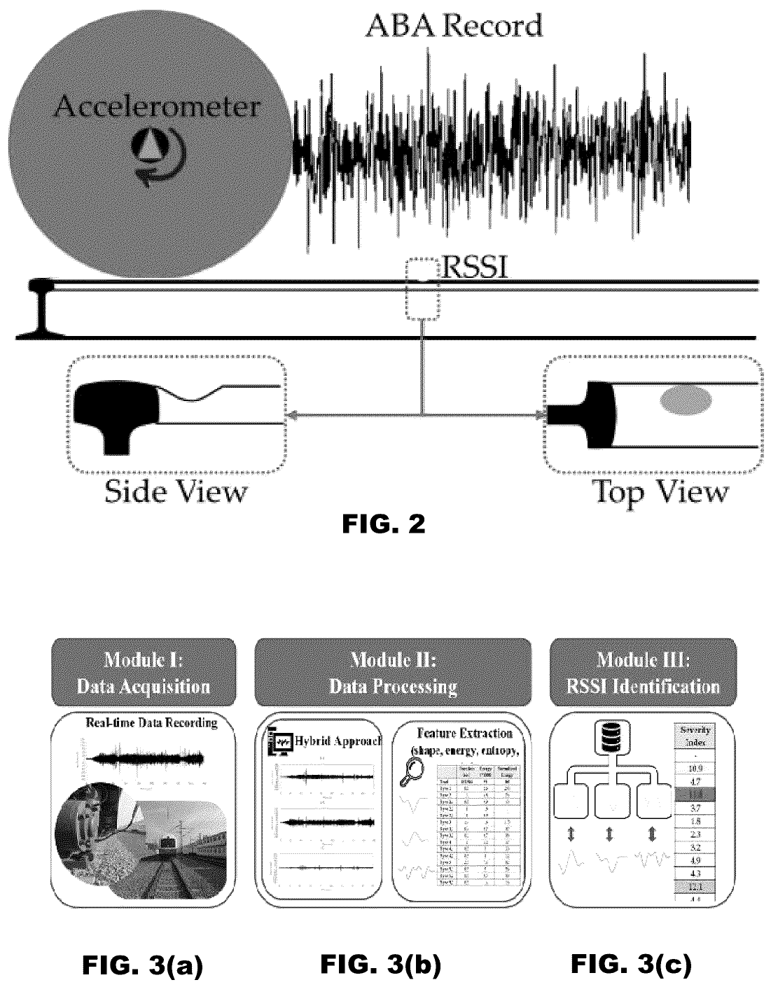

The use of Axle Box Acceleration (ABA) data has been proposed as a possible RSSI detection approach in some studies [36, 37]. FIG. 2 schematically represents an exemplary mounted accelerometer on an exemplary railway axle box and the Axle Box Acceleration (ABA) measurements as the wheel crosses over a representative RSSI. Such an arrangement when used as a test setup offers several advantages, including its non-disruptive and cost-effective integration into railcars during normal operations and the collection of data from loaded tracks, where dynamic impacts from RSSI are more pronounced. By leveraging ABA data, a proactive warning system can be established to prevent the progression of RSSI and support effective corrective maintenance strategies. This presently disclosed approach not only reduces time and resource expenditures but also enables real-time defect identification, facilitating prompt corrective actions. However, ABA records are influenced by non-linear effects and background noise, making it difficult to employ standard signal processing techniques effectively.

The present disclosure introduces an innovative hybrid approach for RSSI detection using ABA records. The presently disclosed approach alleviates the shortcomings of current signal processing techniques by combining the strengths of Wavelet Packet Analysis (WPA) and the Hilbert-Huang Transform (HHT). One exemplary significant aspect of some embodiments of the presently disclosed technology involves assessing the sensitivity of the disclosed method to background noise through a comprehensive parametric assessment, ensuring its reliability in operational environments. The presently disclosed system promises to enhance the efficiency of identifying and addressing RSSI issues promptly, contributing to improved railway maintenance practices.

The presently disclosed system processes records collected by Axle Box Acceleration (ABA) sensors installed on railcars acquiring data at service speeds. The RSSI detection algorithms are based on a novel, hybrid signal processing technique for feature extraction developed by the PIs (Process Information data systems). The RSSI detection algorithms are validated and qualified in the field. The presently disclosed system integrates sensors, hardware and software into an on-the-edge computing platform for rapid, in-motion RSSI detection and classification. The system components and process can be validated through lab testing and extensive offline field measurements, with the technology adapted to the railroad operating environment. The collective results yield a robust system capable of redefining rail defect detection methodologies.

Certain aspects of the present disclosure relate to generating a validated classification database for automated RSSI classification based on damage characteristics (e.g., wavelength, depth, and shape) and local excitation features (e.g., energy, entropy, power) through recorded or simulated signals. For example, an initial step can be to generate records of the response of trains traveling over track segments containing predetermined RSSI of known characteristics that covers sufficient types of real-time rail surface defects. To this end, a Rapid-3D Vehicle-Track Interaction simulator can be used. Moreover, in order to optimize the onboard detection system, a Damage Severity Index (DSI) with respect to the excitation duration, normalized energy in the decomposed components, and estimated defect shapes can be defined.

Subsequently, a feature extraction tool can be used to detect, characterize, and determine the severity of each data event. The data generated can form the basis for the RSSI classification system, coupled with different defined threshold values associated with different service criteria and risk management.

The presently disclosed algorithm and the RSSI classification system can be used to implement the disclosed detection method in an offline environment using known acceleration time histories of a variety of real-world RSSI exemplary embodiments. In addition to real-world exemplary embodiments, artificial acceleration signals can be generated with arbitrary damage embedded at some location with certain characteristics, to be used for further verification of the method. Software can be implemented to take input acceleration time history and output the RSSI classification, DSI, and location.

Storage needs of the presently disclosed method can be determined for particular embodiments of the presently disclosed technology, including how to efficiently store the outputs. In addition, data acquisition parameters and needs can be determined and/or optimized, e.g., length of track to analyze in a single data packet, speed of train, etc., for particular embodiments.

The presently disclosed signal processing technology to detect rail surface defects in some embodiments integrates directly with other wave-propagation-based inspection technology for rail internal damage detection. Further, in some embodiments, it may be fused with other predictive analytics approaches for railway track monitoring.

In implementing the presently disclosed technology in particular environments or embodiments, anticipated issues with data quality, variability and sensitivity to environmental effects can be resolved through preprocessing that encompasses train speed normalization and cleaning of data, including outlier detection and removal, as needed. Furthermore, adaptive algorithms and calibration can be implemented for handling varying data quality and ensure robust performance under different conditions.

### 2. HYBRID SIGNAL PROCESSING

The presently disclosed novel hybrid signal processing approach integrates the WPA and HHT techniques combining their advantages while alleviating shortcomings of each. When applied to ABA records, this presently disclosed hybrid approach significantly improves the efficacy of RSSI detection. Initially, WPA is employed to partition the signal into distinct frequency bands, effectively filtering out noise and enhancing overall signal quality. Following this, HHT is applied to filtered signals, enabling the analysis of non-stationary and nonlinear data. The application of HHT facilitates the extraction of instantaneous frequency information, providing insights into changes in amplitude and frequency content over time. This integrated approach offers a robust and comprehensive strategy for enhancing the detection capabilities in RSSI.

### 2.1 Wavelet Basics

WPA is commonly applied in damage detection across various fields due to its ability to analyze signals in both time and frequency domains simultaneously. The mathematical definition of the WPA involves a multi-layer wavelet packet decomposition and can be expressed as follows [38]:

$$\begin{matrix}{ψ}_{j , k}^{i} ( t ) = \sqrt{{2}^{j}} {ψ}^{i} ( {2}^{j} t - k ) , & i = 0 , 1 , 2 , …\end{matrix} \qquad ( 1 )$$

where ψ_{j,k}ⁱ(t) is the wavelet packet function; ψ^{j} is the wavelet basis function; i, j and k are the modulation coefficient, scale coefficient and translation coefficient of the wavelet function, respectively, and t is the time parameter of the wavelet function. When i=0, ψ_{j,k}⁰(t)=φ(t) is the scaling function, and when i=1, ψ_{j,k}¹(t)=ψ(t) is the wavelet function.

Equations (2) and (3) depict the recursive and iterative decomposition process of the wavelet packet decomposition.

$${ψ}^{2 j} ( t ) = \sqrt{2} {{\sum }_{k = - ∞}}^{∞} h ( k ) {ψ}^{i} ( {2}^{j} t - k ) \qquad ( 2 )$$

$${ψ}^{2 j + 1} ( t ) = \sqrt{2} {{\sum }_{k = - ∞}}^{∞} g ( k ) {ψ}^{i} ( {2}^{j} t - k ) \qquad ( 3 )$$

where h(k) and g(k)=(−1)ⁿh(1−k) are the response function of low-pass and high-pass filters in the signal wavelet packet decomposition, respectively.

The maximum level of decomposition can be calculated from log₂(fₛ/fₘᵢₙ) where fₛ and fₘᵢₙ are respectively the sampling rate and minimum frequency. The signal y(t) is subjected to j-layer WPA, resulting in obtaining 2^{j} wavelet packet coefficients.

### 2.2 The Hilbert-Huang Transform (HHT)

HHT is an adaptive signal processing method developed by Huang et al. [39]. It is especially effective in analyzing nonlinear and non-stationary data, which are commonly observed characteristics in ABA measurements. Essentially, HHT consists of two fundamental components: Empirical Mode Decomposition (EMD) and Hilbert spectral analysis [40]. EMD decomposes a signal into Intrinsic Mode Functions (IMFs) sorted by their frequency bands, enabling effective identification of oscillatory modes and anomalies relevant to RSSI. After EMD, the Hilbert transform of signal S(t), defined as

$$H ( t ) = \frac{1}{π} P \int \frac{S ( τ )}{t - τ} d τ \qquad ( 4 )$$

where P is the Cauchy principal value, is applied to each IMF, producing instantaneous frequency data used to generate a Hilbert spectrum.

EMD is a process in HHT intended to reveal non-stationary components in different frequency bands. EMD outputs are IMFs in which any nonstationary data can be represented. Each IMF needs to satisfy two conditions: i) the total number of extrema and zero-crossings in the whole dataset must be equal or at most have a difference of one; ii) at any given point, it is expected that the average value of the envelope formed by the local maximums and the envelope formed by the local minimums would be zero [41].

Subsequently, the Hilbert spectrum acts as a tool for the analysis of time-frequency data. It presents the way the amplitude and frequency content of the signal evolves over time, thereby serving as an effective instrument for detecting RSSI through ABA.

### 2.3 RSSI Detection Process Modules

FIGS. 3(a) through 3(c) respectively represent diagrammatically three successive modules or phases of the presently disclosed RSSI detection methodology. Module I involves collecting data from the simulation environment or from the field using accelerometers attached to train axle boxes, along with recording train speed profile and GPS information. Module II synchronizes the various recorded data and feeds them into the presently disclosed hybrid (WPA-HHT) algorithm for decomposition, denoising, reconstruction, and feature extraction of the signal. Module III utilizes the results from Module II and focuses on non-stationary features to identify localized anomalies in the system, and to detect and classify the identified RSSI based on feature power.

### 3. RESULTS AND DISCUSSION

This section aims to assess the capability of detecting a specific RSSI in a random path and embedded in noisy environments using the presently disclosed methodology (Modules I, II, and III).

### 3.1 Model Description

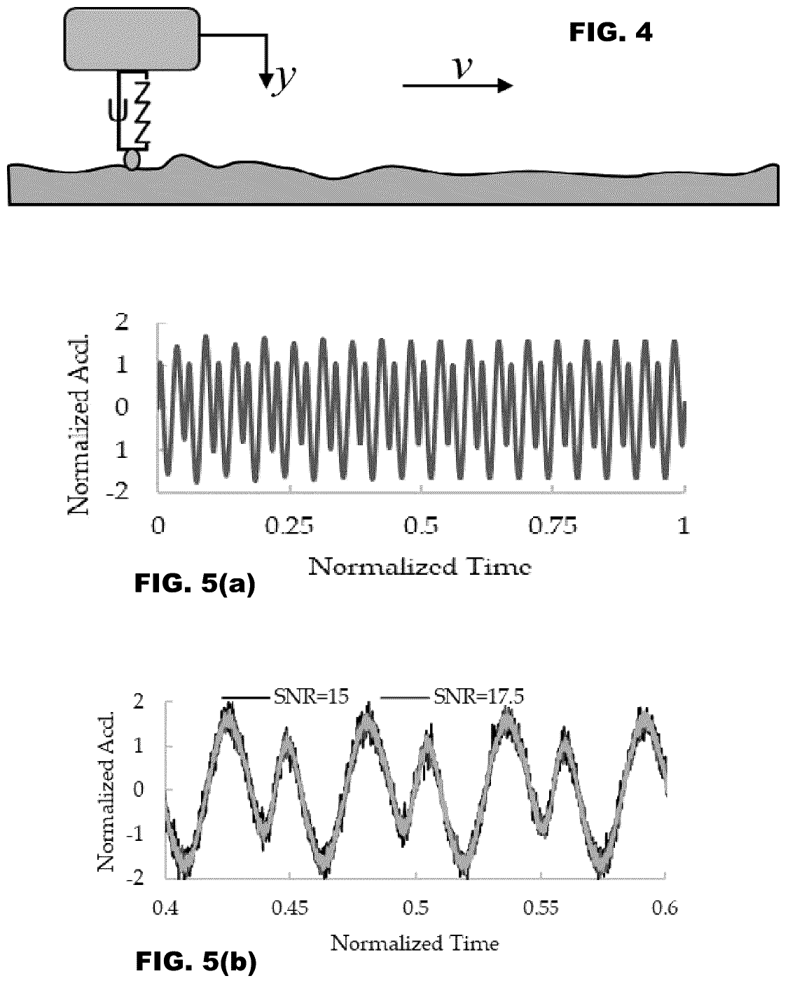

To evaluate the presently disclosed framework, a moving oscillator traveling over an uneven surface is chosen. FIG. 4 schematically represents the interaction of an exemplary single degree-of-freedom oscillator on an irregular surface (such as a railway rail). In order to have consistency at each time step, the oscillator is considered to navigate through the path at constant speed. This simulation primarily focuses on indirectly assessing surface monitoring by tracking the response of the moving system along the entire length of the path. It is evident that this specific exemplary embodiment concentrates on detecting surface spot defects resembling RSSI with instantaneous frequency components. Therefore, certain flaws in the moving system fall outside the frequency range relevant to the local defects or result in repetitive excitations within the simulator response, which are not the primary focus of some presently disclosed embodiments. The result of this simulation environment can be employed to evaluate the effectiveness of the presently disclosed algorithm for detecting local defects using onboard measurements. Furthermore, the influence of two signal-to-noise ratios (SNR) has been evaluated in a controlled environment to examine the effect of noise on the system.

The oscillator in this simulation is characterized by a natural frequency of 188.5 rad/sec and a damping ratio of 2%. It travels at a constant speed of 60 km/h, covering a distance of 20 m. Surface irregularities, described in Equation (5) consist of two distinct terms commonly employed in the literature [33, 42]. The first term replicates localized imperfections similar to RSSI, while the second term accounts for random long-wavelength irregularities along the path, with wavelengths ranging from 20 to 100 cm and depths from 0.1 to 2 mm.

$$r ( t ) = {\sum }_{n = 1}^{N} χ \frac{{δ}_{n}}{2} ( 1 - cos ( 2 π \frac{v t}{{l}_{n}} ) ) + {\sum }_{m = 1}^{M} {δ}_{m} sin ( 2 π \frac{vt}{{l}_{m}} ) \qquad ( 5 )$$

where N and M are the number of RSSI and random irregularity modes; χ is the RSSI location function; δ, l, and v are the depth, length, and speed, respectively.

The suggested relationship for the surface roughness is integrated into the vertical movement of the oscillator, and the system behavior can be expressed by the following equation:

$$\ddot{z} + 2 ξ {ω}_{n} ( \dot{z} - \dot{r} ) + {ω}_{n}^{2} ( z - r ) = 0 \qquad ( 6 )$$

where \ddot{z}, ż, and z are, respectively, the acceleration, velocity, and displacement of the oscillator. ωₙ, and ξ are the natural frequency and damping ratio, respectively.

Incorporating a surface spot irregularity measuring 4.39 cm in length and 0.5 mm in depth, the simulation calculated a prominent frequency component of 380 Hz, indicating the presence of RSSI. To evaluate the presently disclosed RSSI detection method, background noise was introduced into the acceleration signal measured at 10 kHz. Gaussian white noise with SNR values of 15 and 20 dB was strategically introduced to perturb and disperse vibrations generated by surface irregularities [43], per Equation (7):

$$SNR ( dB ) = 10 {log}_{10} ( \frac{{\sum }_{i = 1}^{N} {X}_{i}^{2}}{{{\sum }_{i = 1}^{N} [ {\hat{X}}_{i} - {X}_{i} ]}^{2}} ) \qquad ( 7 )$$

where Xᵢ and \hat{X}ᵢ are the original signal and the predicted signal, respectively.

### 3.2 Module I: Data Acquisition

Module I is assigned to the crucial task of gathering fundamental data for a detailed analysis of the dynamics of the moving oscillator as it navigates through an uneven path. FIG. 5(a) provides a visual representation of the normalized acceleration of the oscillator (such as represented in present FIG. 4) throughout its motion, offering a comprehensive insight into its behavior. Notably, this signal intentionally undergoes exposure to noisy environments, deliberately adding a layer of complexity to the acquired data. Consequently, the noise will disrupt or scatter the vibrations resulting from irregularities on the surface, leading to the elimination of specific frequency ranges that contain important elements of the signal.

In particular, FIG. 5(b) offers a closer examination of the signal at the defected location in the middle of the path, by graphically illustrating an enlarged representation of an exemplary oscillator signal in an exemplary defected location in the middle of the path of the exemplary oscillator. It becomes evident that the instantaneous signal is entirely masked in noisy environments.

This intentional focus allows for a detailed investigation and analysis of how the oscillator's acceleration responds when faced with irregularities along its path, taking into account the presence of noise. The intentional introduction of noise and the deliberate masking of defected locations contribute to a robust dataset, forming the foundation for subsequent analyses in the comprehensive evaluation of the presently disclosed framework.

### 3.3 Module II: Data Processing

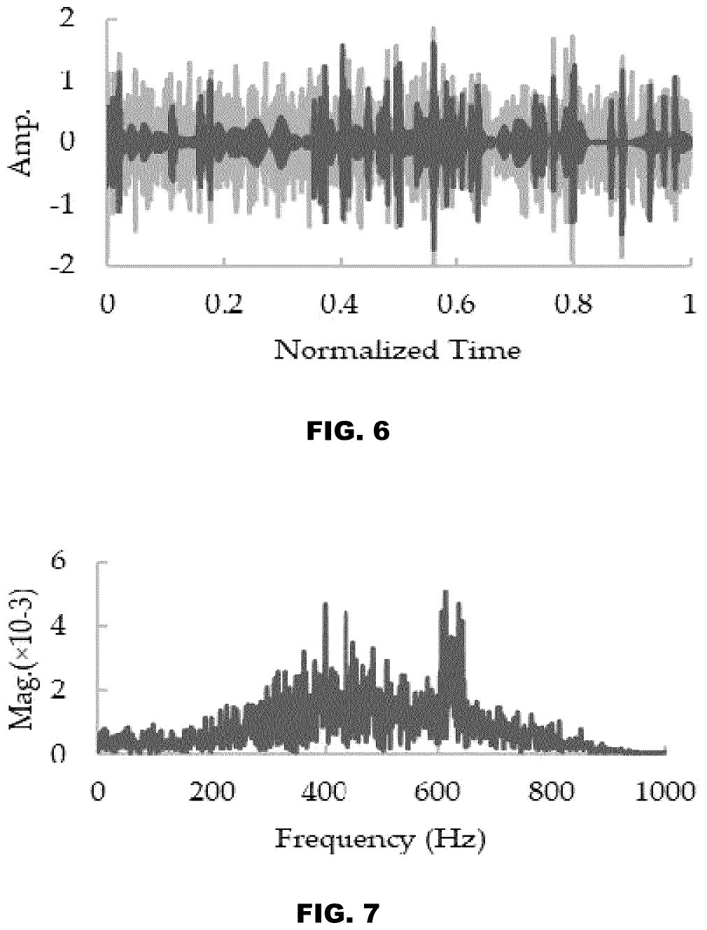

In this module, as mentioned earlier the initial step involves synchronizing the recorded signals with the oscillator location over time. Then the synchronized data is passed through the presently disclosed hybrid algorithm to decompose to the frequency ranges related to localized defects and then denoising and reconstruction. A graphical representation of an exemplary output signal of the presently disclosed methodology, as output from the Wavelet Packet Analysis (WPA) portion thereof for illustrating high-frequency components, is illustrated in FIG. 6 for SNR=15. In the gray scale representation of FIG. 6, gray represents noisy signal output and black represents denoised signal output. This illustrative representation serves as a testimony to the efficacy of the technique in not only isolating but also strengthening relevant frequency components, thereby amplifying the overall signal quality.

The modified signal, demonstrating higher quality and a lower level of noise as depicted in FIG. 6, aligns with the target frequencies identified in this exemplary embodiment for localized imperfections. FIG. 7, in accordance with exemplary presently disclosed methodology, graphically represents the frequency details (distribution) of the modified signal of FIG. 6, providing a comprehensive view into the specific frequency components that are of importance in the context of identifying and characterizing localized imperfections, for analysis purposes.

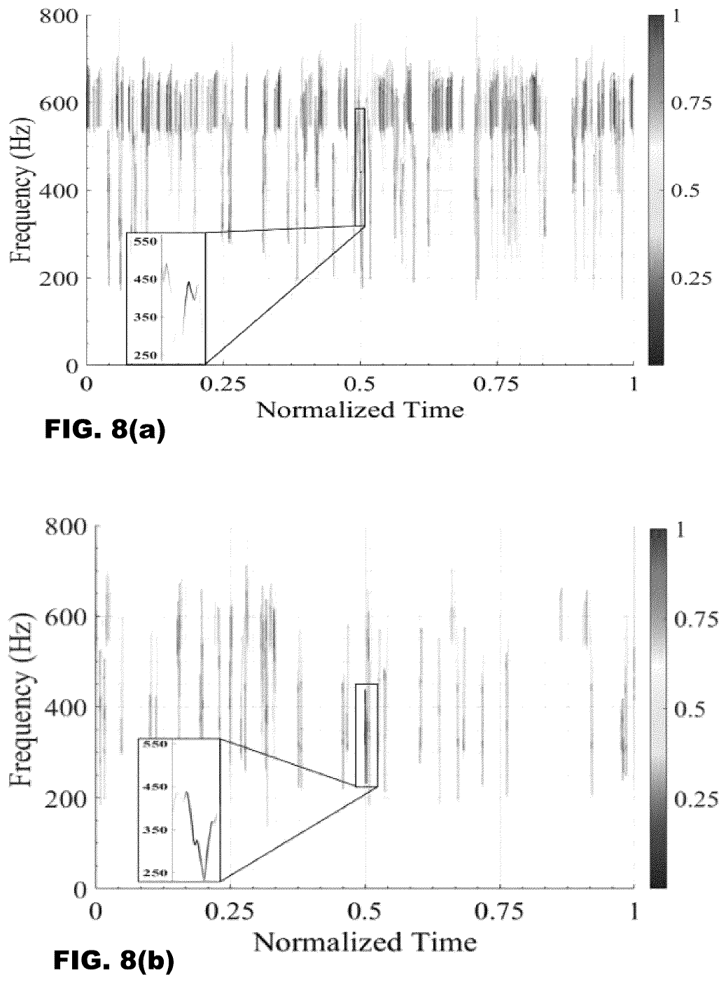

To enhance the efficiency of RSSI detection, the refined signal undergoes further refinement through the HHT process. This transformative step involves deriving the complex analytical signal, utilizing the power of HHT to reveal hidden details within the modified signal. This strategic utilization of HHT contributes to a more comprehensive analysis, providing valuable insights that enhance the overall efficacy of the RSSI detection process. The results of the HHT are visually depicted in FIG. 8, displaying the detailed characteristics of the refined signal.

### 3.4 Module III: RSSI Identification

In Module III, the focus turns to RSSI identification. This involves tracking the instantaneous energy of the signal output from Module II to find the highest amount of instantaneous energy in the signal. This crucial feature reveals moments of abrupt and short-duration excitations, indicative of localized imperfections like RSSI. The spectrums displayed in FIGS. 8(a) and 8(b) graphically represent time-frequency representations of the analytic signals after further refinement through the HHT phase of the presently disclosed process, shown along the entire pathway for both representative noisy environments of introduced Gaussian white noise with SNR values of 15 and 20 dB, respectively.

Based on the presently disclosed method, the highest amount of instantaneous energy is identified in the middle of the path where the initial RSSI is placed. Notably, this accurate localization withstands challenges posed by noisy environments, highlighting the method's effectiveness in overcoming limitations seen in existing literature. Further analysis through zoomed-in pictures reveals that the highest amplitude of instantaneous energy occurs within the frequency range of 340 to 390 Hz. Considering the oscillator's speed, this frequency range aligns closely with lengths corresponding to the defined imperfection length of 4.39 cm, providing robust evidence of the presently disclosed method's precision in identifying and characterizing RSSI.

### 4. CONCLUSION

The present disclosure introduces an innovative RSSI detection algorithm based on a hybrid approach for onboard ABA systems. This algorithm proves highly effective at identifying rail surface damage. Key findings include efficient RSSI location prediction and defect size identification. The algorithm's versatility allows seamless implementation across all railcars, offering comprehensive network-wide monitoring capabilities and improving overall safety and operational efficiency in railway systems. The presently disclosed hybrid method was preliminarily applied to real-time train data, yielding promising results. With over 95% compression of field data, the method successfully detected RSSIs in a 700-meter track segment during regular traffic, highlighting its efficacy in operational railway environments.

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims.

In any event, while certain embodiments of the disclosed subject matter have been described using specific terms, such description is for illustrative purposes only, and it is to be understood that changes and variations may be made without departing from the spirit or scope of the subject matter. Also, for purposes of the present disclosure, the terms “a” or “an” entity or object refers to one or more of such entity or object. Accordingly, the terms “a”, “an”, “one or more,” and “at least one” can be used interchangeably herein.

### REFERENCES

[1] Nielsen, J. C. and e. al., Train-track interaction and mechanisms of irregular wear on wheel and rail surfaces. Vehicle system dynamics, 2003. 40 (1-3): p. 3-54.
[2] Liu, X., T. Turla, and Z. Zhang, Accident-cause-specific risk analysis of rail transport of hazardous materials. Transportation research record, 2018. 2672 (10): p. 176-187.
[3] Liu, X., C. P. Barkan, and M. R. Saat, Analysis of derailments by accident cause: evaluating railroad track. Transportation research record, 2011. vol. 2261 (1): p. 178-185.
[4] Federal Railroad Administration, Accident data as reported by railroads. Available from: https://railroads.dot.gov/accident-and-incident-reporting/overview-reports/accident-data-reported-railroads.
[5] Naseri, R. and S. Mohammadzadeh, Nonlinear Train-Track-Bridge Interaction with Unsupported Sleeper Group. International Journal of Railway Research, 2020. 7 (1): p. 11-28.
[6] Tao, H. and P. Zhang, Characterization and mitigation of wheel-rail impact at a singular rail defect. Journal of Vibration and Control, 2022: p. 10775463221122111.
[7] Kaewunruen, S., S. M. Ishida, and S. Marich, Dynamic wheel-rail interaction over rail squat defects. Acoustics Australia, 2015. 43 (1): p. 97-107.
[8] Mandal, N. K., M. Dhanasekar, and Y. Q. Sun, Impact forces at dipped rail joints. Proceedings of the Institution of Mechanical Engineers, Part F: Journal of Rail and Rapid Transit, 2016. 230 (1): p. 271-281.
[9] Gedney, B. L. and D. C. Rizos, Combining welding-induced residual stress with thermal and mechanical stress in continuous welded rail. Results in Engineering, 2022. 16: p. 100777.
[10] Xu, J. and e. al., Geometry evolution of rail weld irregularity and the effect on wheel-rail dynamic interaction in heavy haul railways. Engineering Failure Analysis, 2017. 81: p. 31-44.
[11] Liu, H., J. Yang, and T. Wu, The influence of rail vibration absorber on normal wheel-rail contact forces due to multiple wheels. Journal of Vibration and Control, 2015. 21 (2): p. 275-284.
[12] Dynamic characterisation of the wheel/rail contact using ultrasonic reflectometry. Transportation research record, 2011. 2261 (1): p. 178-185.
[13] Gao, J., W. Zhai, and Y. Guo, Wheel-rail dynamic interaction due to rail weld irregularity in high-speed railways. Proceedings of the Institution of Mechanical Engineers, Part F: Journal of Rail and Rapid Transit, 2018. 232 (1): p. 249-261.
[14] Meymand, S. Z., A. Keylin, and M. Ahmadian, A survey of wheel-rail contact models for rail vehicles. Vehicle System Dynamics, 2016. 54 (3): p. 386-428.
[15] Naseri, R., S. Mohammadzadeh, and D. C. Rizos, Rail surface spot irregularity effects in VTI simulations of train-track-bridge interaction. Journal of Vibration and Control, 2024.
[16] Naseri, R., Consequences of rail surface local irregularities on railway concrete bridge vibrations. 2020, Iran University of Science and Technology (IUST).
[17] Li, Z., et al., Squat growth—Some observations and the validation of numerical predictions. Wear, 2011. 271 (1-2): p. 148-157.
[18] Steenbergen, M. J., Quantification of dynamic wheel-rail contact forces at short rail irregularities and application to measured rail welds. Journal of Sound and Vibration, 2008. 312 (4-5): p. 606-629.
[19] Zhou, L., et al., Dynamic characterisation of the wheel/rail contact using ultrasonic reflectometry. Proceedings of Railways 2014, Conference on Railway Technology: Research, Development and Maintenance (2014): p. 8-11.
[20] Heydari, H., N. Khanie, and R. Naseri, Formulation and Evaluation of the Ballast Shear Interlocking Coefficient based on Analytical, Experimental, and numerical Analyses. Construction and Building Materials, 2023. 406: p. 133457.
[21] Molodova, M., et al., Automatic detection of squats in railway infrastructure. IEEE Transactions on Intelligent Transportation Systems, 2014. 15 (5): p. 1980-1990.
[22] Zuo, Y., et al., Squat Detection of Railway Switches and Crossings Using Point Machine Vibration Measurements. Sensors, 2023. 23 (7): p. 3666.
[23] Momeni, H. and A. Ebrahimkhanlou, High-dimension data analytics in structural health monitoring and non-destructive evaluation: a review paper. Smart Materials and Structures, 2022.
[24] Park, J. W. and e. al., Rail surface defect detection and analysis using multi-channel eddy current method based algorithm for defect evaluation. Journal of Nondestructive Evaluation, 2021. 40: p. 1-12.
[25] Chenchen, D. L., L. Wenbo, and C. Wangcai, Rail crack recognition based on multi-sensor feature-decision fusion. Meas. Technology, 2017. 40 (11): p. 157-160.
[26] Soilán, M., et al., Review of laser scanning technologies and their applications for road and railway infrastructure monitoring. Infrastructures, 2019. 4 (4): p. 58.
[27] Lu, J., et al., SCueU-Net: Efficient Damage Detection Method for Railway Rail. IEEE Access, 2020. 8: p. 125109-125120.
[28] Feng, Q., et al., Automatic rail surface defects inspection based on mask R-CNN. Transportation research record: Journal of the Transportation Research Board, 2021. 2675 (11): p. 655-688.
[29] Hailang, L., et al., Ensemble model for rail surface defects detection. PLOS one 17, 2022.
[30] Li, Q. and S. Ren, A visual detection system for rail surface defects. IEEE Transactions on Systems, Man, and Cybernetics, Part C (Applications and Reviews), 2012: p. 1531-1542.
[31] Bai, T., et al., A study on railway surface defects detection based on machine vision. Entropy 23, 2021.
[32] Cho, H. and J. Park Study of Rail Squat Characteristics through Analysis of Train Axle Box Acceleration Frequency. Applied Sciences, 2021. 11, DOI: 10.3390/app11157022.
[33] Yuan, Z., et al., An unsupervised method based on convolutional variational auto-encoder and anomaly detection algorithms for light rail squat localization. Construction and Building Materials, 2021. 313: p. 125563.
[34] Wei, X., et al., Squats and corrugation detection of railway track based on time-frequency analysis by using bogie acceleration measurements. Vehicle System Dynamics, 2020. 58 (8): p. 1167-1188.
[35] Shadfar, M. and H. Molatefi, Detection of rail local defects using in-service trains. Proceedings of the Institution of Mechanical Engineers, Part F: Journal of Rail and Rapid Transit, 2022. 236 (9): p. 1114-1123.
[36] Cho, H. and J. Park, Study of Rail Squat Characteristics through Analysis of Train Axle Box Acceleration Frequency. Applied Sciences, 2021. 11 (15): p. 7022.
[37] Li, Z., et al., Improvements in axle box acceleration measurements for the detection of light squats in railway infrastructure. IEEE Transactions on Industrial Electronics, 2015. 62 (7): p. 4385-4397.
[38] Akujuobi, C. M., Wavelets and wavelet transform systems and their applications. 2022: Springer.
[39] Huang, N. E., et al., The empirical mode decomposition and the Hilbert spectrum for nonlinear and non-stationary time series analysis. Proceedings of the Royal Society of London. Series A: mathematical, physical and engineering sciences, 1998. 454 (1971): p. 903-995.
[40] Souza, U. B. d., J. P. L. Escola, and L. d. C. Brito, A survey on Hilbert-Huang transform: Evolution, challenges and solutions. Digital Signal Processing, 2022. 120: p. 103292.
[41] Huang, N. E. and N. O. Attoh-Okine, The Hilbert-Huang transform in engineering. 2005: CRC Press.
[42] Liu, X., et al., An indirect method for rail corrugation measurement based on numerical models and wavelet packet decomposition. Measurement, 2022. 191: p. 110726.
[43] He, C., et al., A new wavelet thresholding function based on hyperbolic tangent function. Mathematical Problems in Engineering, 2015. 2015.

What is claimed is:

1. Method for the identification of Rail Surface Spot Irregularities (RSSI) of a rail system, comprising:
collecting field data using at least one accelerometer attached to at least one railcar axle box while synchronously recording associated railcar speed profile and GPS information;
processing collected field data using a two stage process of Wavelet Packet Analysis (WPA) and the Hilbert-Huang Transform (HHT) for detecting localized anomalies in the rail system; and
identifying and classifying RSSI based on the detected localized anomalies output of the two stage process.

2. The method according to claim 1, wherein detecting, identifying and classifying RSSI includes identifying locations and dimensions of the detected localized anomalies on each surface in the rail system based on the synchronously recorded associated railcar speed profile and GPS information.

3. The method according to claim 1, further comprising:
a plurality of accelerometers attached to a plurality of respective railcar axle boxes; and
wherein WPA processing partitions the collected field data into distinct frequency bands, for filtering out noise to provide filtered signals.

4. The method according to claim 3, wherein WPA processing further includes hard thresholding to preserve abrupt signal changes, data compression comprising storing coefficients instead of actual signals, filtering for noise on coefficients, and providing the filtered signal through reconstruction using the filtered coefficients.

5. The method according to claim 3, wherein HHT processing is applied to the filtered signals, for extracting instantaneous signal information, to detect changes in at least one of amplitude, frequency, time, and energy content over time.

6. The method according to claim 5, wherein:
the HHT processing includes extracting instantaneous frequency information; and
detecting and classifying includes tracking the instantaneous frequency information from the HHT processing to find the highest amount of instantaneous energy in the filtered signals, for detecting signal locations of abrupt and short-duration excitations to indicate localized imperfections.

7. The method according to claim 6, conducting further signal processing to compare detected excitations with defined threshold values associated with different service criteria and risk management technology to detect, characterize, and determine the severity of each rail surface anomaly, to identify anomalies comprising RSSI for maintenance treatment.

8. The method according to claim 1, further comprising preprocessing collected field data and associated speed profile and GPS information for establishing railcar speed normalization, prior to processing with the two stage WPA/HHT process.

9. The method according to claim 1, wherein:
the railcar comprises a railcar of a train active at normal service speeds, or part of a specialized track inspection or track measurement vehicle; and
the processing of collected field data is conducted either in real time or offline.

10. A detection system for the identification of Rail Surface Spot Irregularities (RSSI) of a rail system, comprising:
at least one accelerometer attached to at least one railcar axle box for collecting Axle Box Acceleration (ABA) field data obtained from the at least one railcar axle box; and
one or more processors programmed for
synchronously recording associated railcar speed profile and GPS information,
processing collected data using a two stage process of Wavelet Packet Analysis (WPA) and the Hilbert-Huang Transform (HHT) for detecting localized anomalies in the rail system, and
identifying and classifying RSSI based on the detected localized anomalies output of the two stage process.

11. The detection system according to claim 10, wherein the one or more processors are further programmed for identifying and classifying RSSI to include identifying locations and dimensions of the detected localized anomalies on each surface in the rail system based on the synchronously recorded associated railcar speed profile and GPS information.

12. The detection system according to claim 10, further comprising:
a plurality of accelerometers attached to a plurality of respective railcar axle boxes; and
wherein the one or more processors are further programmed so that WPA processing partitions the collected field data into distinct frequency bands, for filtering out noise to provide filtered signals.

13. The detection system according to claim 12, wherein the one or more processors are further programmed so that WPA processing further includes hard thresholding to preserve abrupt signal changes, data compression comprising storing coefficients instead of actual signals, filtering for noise on coefficients, and providing the filtered signal through reconstruction using the filtered coefficients.

14. The detection system according to claim 12, wherein the one or more processors are further programmed so that HHT processing is applied to the filtered signals, for extracting instantaneous signal information, to detect changes in at least one of amplitude, frequency, time, and energy content over time.

15. The detection system according to claim 14, wherein the one or more processors are further programmed so that:
the HHT processing includes extracting instantaneous frequency information; and
detecting and classifying includes tracking the instantaneous frequency information from the HHT processing to find the highest amount of instantaneous energy in the filtered signals, for detecting signal locations of abrupt and short-duration excitations to indicate localized imperfections.

16. The detection system according to claim 15, wherein the one or more processors are further programmed for conducting further signal processing to compare detected excitations with defined threshold values associated with different service criteria and risk management technology to detect, characterize, and determine the severity of each rail surface anomaly, to identify anomalies comprising RSSI for maintenance treatment.

17. The detection system according to claim 10, wherein the one or more processors are further programmed for preprocessing collected field data and associated speed profile and GPS information for establishing railcar speed normalization, prior to processing with the two stage WPA/HHT process.

18. The detection system according to claim 10, wherein:
the railcar comprises a railcar of a train active at normal service speeds, or part of a specialized track inspection or track measurement vehicle; and
the processing of collected field data is conducted either in real time or offline.

19. A hybrid methodology for using field data from in-service trains to predict Rail Surface Spot Irregularities (RSSI) of a rail system used by the trains, to provide continuous rail surface health monitoring at train operating speeds, to allow for maintenance for determined RSSI, comprising:
conducting automated collecting of Axle Box Acceleration (ABA) data obtained from in-service trains having at least one instrumented railcar;
synchronously recording associated train speed profile and GPS information with the ABA data;
conducting hybrid processing of the recorded field data and associated speed profile and GPS information by:
first conducting Wavelet Packet Analysis (WPA) processing to partition the recorded field data into distinct frequency bands, for filtering out noise to provide filtered signals, and
secondly conducting Hilbert-Huang Transform (HHT) processing on the filtered signals from the WPA processing to extract instantaneous frequency information, to detect changes in amplitude and frequency content over time, for analysis of non-stationary and nonlinear data for detecting localized defects on the rails of the rail systems used by the trains; and
identifying and classifying RSSI based on the detected localized defects detected by the hybrid processing.

20. The hybrid methodology according to claim 19, wherein WPA processing further includes hard thresholding to preserve abrupt signal changes, data compression comprising storing coefficients instead of actual signals, filtering for noise on coefficients, and providing the filtered signal through reconstruction using the filtered coefficients.

21. The hybrid methodology according to claim 19, wherein:
identifying and classifying RSSI includes comparing data on detected localized defects with defined threshold values associated with different service criteria and risk management technology to detect, characterize, and determine the severity of each rail surface defect, to identify defects comprising RSSI for maintenance treatment; and
said method further comprises recommending maintenance treatment on identified RSSI.

22. The hybrid methodology according to claim 21, further comprising communicating identified RSSI in real-time or in offline delayed time for enabling maintenance treatment.

23. The hybrid methodology according to claim 19, further comprising preprocessing recorded field data and associated speed profile and GPS information for establishing train speed normalization, prior to processing with the hybrid WPA/HHT process.

24. The hybrid methodology according to claim 19, wherein the Hilbert-Huang Transform (HHT) processing provides adaptive signal processing method for analyzing nonlinear and non-stationary data by first conducting Empirical Mode Decomposition (EMD) comprising decomposing a signal into Intrinsic Mode Functions (IMFs) sorted by frequency bands, for effective identification of oscillatory modes and anomalies relevant to RSSI, and secondly conducting Hilbert spectral analysis.

25. The hybrid methodology according to claim 19, wherein detecting and classifying RSSI includes predicting the length and location of RSSI along rails of the rail systems used by the trains.
